(19) United States
(12) Patent Application Publication
(10) Pub. No.: US 2023/0062203 A1
(43) Pub. Date: Mar. 2, 2023

(54) GEAR UNIT ASSEMBLY FOR AN ENGINE WITH LEAKAGE RECOVERY

(71) Applicant: Rolls-Royce Deutschland Ltd & Co KG, Blankenfelde-Mahlow (DE)

(72) Inventors: Hannes WÜSTENBERG, Berlin (DE); Jakob VIOLET, Nuthetal (DE)

(21) Appl. No.: 17/896,282

(22) Filed: Aug. 26, 2022

(30) Foreign Application Priority Data
Aug. 30, 2021 (DE) 10 2021 209 489.9

(51) Int. Cl. F02C 7/36; F02C 7/06; F02C 7/28

(52) U.S. Cl. CPC F02C 7/36; F02C 7/06; F02C 7/28; F05D 2260/40311; F05D 2260/60; F05D 2260/84; F05D 2260/98

(57) ABSTRACT

A gear box assembly for an engine, having
a gear box for transmitting a torque,
at least one first, static part,
at least one second, rotating part, which is mounted so as to be rotatable relative to the first, static part and on which at least one element of the gear box is provided, and
a conduit system for conveying a fluid to elements of the gear box,
   wherein the conduit system has at least one first supply line and one second supply line for supplying fluid to at least one element of the gear box.

A leakage recovery facility is provided, by means of which at least a proportion of a leakage flow of fluid which originates from a first duct portion of the first supply line and which flows across at least one seal can be conducted to the second supply line.

This application claims priority to German Patent Application 102021209489.9 filed Aug. 30, 2021, the entirety of which is incorporated by reference herein.

The proposed solution relates to a gear box assembly for an engine.

The prior art, for example DE 10 2017 108 332 A1, has already disclosed a gear box assembly having a gear box by means of which a torque can be transmitted from a low-pressure turbine to a fan of an engine. Here, during the operation of the engine, a core shaft is coupled by means of the gear box of the gear box assembly to the fan of the engine such that the fan rotates at a lower rotational speed than the core shaft. Such a gear box is subjected to extremely high rotational speeds during operation, such that adequate lubrication and cooling of elements of the gear box must be ensured.

From DE 10 2017 108 332 A1, in particular, it is already known for this purpose for a gear box assembly that comprises a gear box to additionally be equipped with a conduit system via which friction-reducing and/or cooling fluid can be conducted to elements of the gear box. Here, the conduit system comprises at least one first supply line for conducting fluid to the gear box element that is to be lubricated and/or cooled, wherein said first supply line comprises a first duct portion in a first, static part of the gear box assembly and a second duct portion in a second, rotating part of the gear box assembly. Here, in order to transfer the friction-reducing and/or cooling fluid from the first duct portion into the second duct portion and thus from the first, static part to the second, rotating part (that is to say the part that rotates during the operation of the gear box), the first and second duct portions are fluidically connected to one another via a transition region. Here, the transition region is sealed off with respect to the second, rotating part by means of at least one seal, for example in the form of a sealing ring. The fluid can thus—in the presence of a conveying pressure for conveying fluid to elements of the gear box—flow from the first duct portion into the second duct portion. A sealing action between the first, static part and the second, rotating part is provided by means of the at least one seal.

Owing to the sealing abutment against the second, rotating part that occurs here, the at least one seal is under some circumstances subject to not inconsiderable wear. On the other hand, however, if the at least one seal does not lie in a fully sealed manner against the second, rotating part under high pressure, the wear is duly reduced, but to the detriment of the sealing action. Not inconsiderable leakage across the at least one seal can then be observed under some circumstances. A corresponding leakage flow across the at least one seal is typically not relevant in terms of safety. However, a corresponding leakage flow means that the quantity of fluid that must be provided has to be taken into consideration in the design of the gear box assembly. Also, an accepted leakage flow must not cause the quantity of friction-reducing and/or cooling fluid to fall to such an extent that adequate lubrication and/or an adequate dissipation of heat at the corresponding functionally relevant gear box elements can no longer be ensured.

It is furthermore also already known from the prior art for a conduit system for a gear box assembly to be configured with at least two supply lines. Here, elements of the gear box can be supplied with fluid in redundant fashion via the different supply lines. It is likewise known to supply fluid to different elements of the gear box via multiple (at least two) supply lines. Here, however, leakage flows between the individual supply lines have hitherto not been taken into consideration in practice. Rather, there has conventionally merely been a focus on the fact that fluid lost via a leakage flow does not give rise to any safety-relevant risks.

Against this background, the proposed solution is based on the object of further improving a gear box assembly for an engine.

This object is achieved by means of a gear box assembly according to Claim 1.

Accordingly, a proposed gear box assembly additionally provides a leakage recovery facility, by means of which at least a proportion of a leakage flow, which originates from a first duct portion of a first supply line and which flows across at least one seal, of fluid that is to be conducted to an element of the gear box can be conducted to a second supply line of a conduit system of the gear box assembly, which second supply line is likewise provided for supplying fluid to at least one element of the gear box.

Here, the first supply line and the second supply line of the conduit system may in principle be provided for providing a redundant supply to one and the same element of the gear box. Alternatively, a design variant is provided in which the first and second supply lines are provided for supplying fluid to different elements of the gear box of the gear box assembly.

In principle, a friction-reducing and/or cooling fluid can be conducted to at least one element of the gear box via the conduit system. The corresponding fluid can thus serve in particular for friction reduction, or lubrication, and/or for the dissipation of heat within the gear box. Here, the at least one seal is provided in order to make possible a transition region between a first duct portion on a first, static part of the gear box assembly and a second duct portion on a second, rotating part of the gear box assembly. Here, the proposed solution is now based on the underlying concept whereby a leakage flow across said at least one seal occurs, or is even allowed at least in a defined limit range, but then at least a proportion of the leakage flow of fluid that flows across the at least one seal is fed to another supply line of the conduit system. The fluid from any leakage at the transition region thus continues to be utilized, in particular for lubrication and/or cooling, in the other, second supply line.

In one design variant, the leakage recovery facility comprises a feed opening which is situated, in relation to an occurring leakage flow, downstream of the at least one seal in the second, rotating part and via which inflowing fluid can be conducted to a connecting conduit that is connected to the second supply line. The at least one feed opening is thus for example provided downstream of the at least one seal and thus so as to be axially spaced apart from the transition region, such that the at least one seal is situated exactly between the feed opening and the transition region that couples the first and second duct portions. Any leakage flow from the transition region across the seal thus passes to the feed opening, via which a recovery of at least a proportion of the leakage flow for the second supply line is made possible. The connecting conduit provided for this purpose may be provided here in particular in the second, rotating part. The feed opening is then in turn part of a conduit section in the second, rotating part, which opens into the connecting conduit to the second supply line.

In order to convey fluid of the leakage flow in the direction of the connecting conduit during the operation of the gear box, the leakage recovery facility may be configured to convey the fluid of the leakage flow through the feed opening and in the direction of the connecting conduit (in particular) under the action of a centrifugal force. Against this background, a conduit portion that adjoins the feed opening is then for example configured to run radially in relation to the rotation axis of the second, rotating part. Fluid that passes across the seal at the transition region can thus, under the action of the centrifugal force on the second, rotating part, be conveyed via the feed opening in the direction of the second supply line.

In one design variant, the leakage recovery facility additionally comprises, downstream of the feed opening, at least one catch plate that projects radially in relation to a rotation axis of the second, rotating part. By means of the radially projecting catch plate, a leakage flow is at least partially blocked from flowing off in an axial direction. A corresponding catch plate can thus assist an inflow into the feed opening, in particular if outflow speeds at a leakage point are relatively high.

The conduit system may have at least two seals which are spaced apart from one another axially in relation to a rotation axis of the second, rotating part, in order to border the transition region axially by means of the at least two seals and radially by means of a portion of the first, static part and a portion of the second, rotating part. In order to then ensure that not only a leakage flow that arises across one of the seals is fed to another, second supply line of the conduit system, one design variant provides for fluid that has flowed out of the transition region both across one and across the other seal to be recovered and conducted to the second supply line. The leakage recovery facility is consequently configured here such that both a leakage flow across one seal and a leakage flow across the other seal is in each case fed at least partially back to the second supply line.

For a recovery of fluid axially—as viewed along a rotation axis of the second, rotating part—to both sides of the transition region, it is for example the case that at least two feed openings are provided in the second, rotating part. Then, fluid that respectively flows in via said at least two feed openings can be conducted to a connecting conduit that is connected to the second supply line. The first and second seals are thus provided between the connecting conduits in an axial direction in relation to the rotation axis of the second, rotating part. Accordingly, the seals and the transition region are situated between the at least two feed openings that are respectively part of one of at least two different conduit portions in the second, rotating part, which conduit portions open in each case into a connecting conduit to the second supply line.

If at least two feed openings are part of the leakage recovery facility, it is also possible for at least two in each case radially projecting catch plates to be provided, which are assigned to a respective feed opening. A first catch plate is thus situated, for example, downstream of a first feed opening in a first axial direction, whereas a second catch plate is provided downstream of a second feed opening in an opposite direction.

In one design variant, the first and second supply lines are provided for the redundant supply of fluid to at least one element of the gear box. Thus, in such a design variant, friction-reducing and/or cooling fluid can be conducted via the first and second supply lines to one and the same element of the gear box, for example a planet carrier, for example in order to assist friction-reduced rotatable mounting of the planet gears, lubricate a toothed gear pairing between planet gears and a sun gear of the planetary gear box, and/or dissipate heat. The first and second supply lines for the provision of a redundant supply to an element of the gear box are intended to ensure that, even in the event of a failure of one supply line, sufficient fluid still passes to the corresponding (gear box) element at least via one other supply line. This is of not insignificant importance for example for a bearing, in particular a plain bearing for the mounting of a planet gear in a high-speed planetary gear box for an engine of an aircraft. It is accordingly necessary here in any case to prevent the plain bearing from running dry during the operation of the engine, so as to prevent a failure of the gear box. Corresponding first and second supply lines for the redundant supply of fluid may in this case also be coupled to at least two different pumps, which make fluid available in the conduit system via two different circuits. If, on the basis of the proposed solution, a leakage recovery facility is provided in such a design variant, by means of which leakage recovery facility at least a proportion of a leakage flow of one supply line can be made usable again for the other supply line, the robustness of the overall system can be further improved, and a fluid quantity that must be provided in a fluid reservoir can be reduced, which can contribute to a weight saving.

In another design variant, it may be possible for fluid to be supplied to different elements of the gear box via the first and second supply lines. In this context, too, the proposed leakage recovery facility is associated at least with the advantage whereby fluid that is “lost” at one supply line is made at least partially or fully usable in the other supply line. Also, an intentionally accepted increased leakage can be expedient for the service life of a seal.

In principle, the gear box of the gear box assembly may be a planetary gear box.

Alternatively or in addition, the fluid may be oil, such that the conduit system is part of an oil supply, in particular of an oil supply for a planet carrier of a planetary gear box. As already discussed above, this encompasses in particular the possibility whereby the conduit system is provided for lubricating a bearing arrangement by means of which a planet gear of the planetary gear box is mounted rotatably on the planet carrier.

In one design variant, the first and second duct portions of the first supply line are arranged radially offset with respect to one another in relation to a rotation axis of the gear box. An outflow opening or multiple outflow openings of the first duct portion into the transition region is/are thus situated radially opposite an inflow opening or multiple inflow openings of the second duct portion at the transition region, such that fluid can flow across the transition region from the first duct portion into the second duct portion if a corresponding delivery pressure is applied to the fluid in the conduit system.

The proposed solution furthermore relates to an engine having a design variant of a proposed gear box assembly. This encompasses, in particular, an engine which has at least one core engine and one fan. The core engine then comprises a turbine, a compressor and a core shaft that connects the turbine to the compressor, wherein the fan is positioned upstream of the core engine and comprises multiple fan blades. The gear box of the gear box assembly can be driven by the core shaft in order to drive the fan at a lower rotational speed than the core shaft by means of the gear box.

As noted elsewhere herein, the present disclosure may relate to a gas turbine engine, for example an aircraft engine. Such a gas turbine engine may comprise a core engine comprising a turbine, a combustor, a compressor, and a core shaft connecting the turbine to the compressor. Such a gas turbine engine may comprise a fan (with fan blades) which is positioned upstream of the core engine.

Arrangements of the present disclosure may be advantageous in particular, but not exclusively, for geared fans, which are driven via a gear box. Accordingly, the gas turbine engine may comprise a gear box which is driven via the core shaft and whose output drives the fan in such a way that it has a lower rotational speed than the core shaft. The input to the gear box may be provided directly from the core shaft, or indirectly via the core shaft, for example via a spur shaft and/or spur gear. The core shaft may be connected rigidly to the turbine and the compressor, such that the turbine and compressor rotate at the same rotational speed (with the fan rotating at a lower rotational speed).

The gas turbine engine as described and/or claimed herein may have any suitable general architecture. For example, the gas turbine engine may have any desired number of shafts that connect turbines and compressors, for example one, two or three shafts. Purely by way of example, the turbine connected to the core shaft may be a first turbine, the compressor connected to the core shaft may be a first compressor, and the core shaft may be a first core shaft. The core engine may furthermore comprise a second turbine, a second compressor, and a second core shaft, which connects the second turbine to the second compressor. The second turbine, the second compressor and the second core shaft may be arranged so as to rotate at a higher rotational speed than the first core shaft.

In such an arrangement, the second compressor may be positioned axially downstream of the first compressor. The second compressor may be arranged to receive (for example directly receive, for example via a generally annular duct) a flow from the first compressor.

The gear box may be designed to be driven by the core shaft that is configured to rotate (for example during use) at the lowest rotational speed (for example the first core shaft in the example above). For example, the gear box may be designed to be driven only by the core shaft that is configured to rotate (for example during use) at the lowest rotational speed (for example only by the first core shaft and not by the second core shaft, in the example above). Alternatively, the gear box may be designed to be driven by one or more shafts, for example the first and/or second shaft in the example above.

In a gas turbine engine as described and/or claimed herein, a combustor may be provided axially downstream of the fan and compressor (or compressors). For example, the combustor may be directly downstream of (for example at the exit of) the second compressor, if a second compressor is provided. By way of a further example, the flow at the exit of the compressor may be fed to the inlet of the second turbine, when a second turbine is provided.

The combustor may be provided upstream of the turbine(s).

The or each compressor (for example the first compressor and the second compressor as described above) may comprise any number of stages, for example multiple stages. Each stage may comprise a series of rotor blades and a series of stator blades, which may be variable stator blades (that is to say the angle of attack may be variable). The series of rotor blades and the series of stator blades may be axially offset from one another.

The or each turbine (for example the first turbine and the second turbine as described above) may comprise any number of stages, for example multiple stages. Each stage may comprise a row of rotor blades and a row of stator blades. The series of rotor blades and the series of stator blades may be axially offset from one another.

Each fan blade may have a radial span extending from a root (or a hub) at a radially inner location over which gas flows, or from a span position of 0%, to a tip at a span position of 100%. The ratio of the radius of the fan blade at the hub to the radius of the fan blade at the tip may be less than (or of the order of): 0.4, 0.39, 0.38, 0.37, 0.36, 0.35, 0.34, 0.33, 0.32, 0.31, 0.3, 0.29, 0.28, 0.27, 0.26 or 0.25. The ratio of the radius of the fan blade at the hub to the radius of the fan blade at the tip may be in a closed interval delimited by two values in the previous sentence (that is to say the values may form upper or lower limits). These ratios can commonly be referred to as the hub-to-tip ratio. The radius at the hub and the radius at the tip may both be measured at the leading edge (or the axially forwardmost edge) of the blade. The hub-to-tip ratio refers, of course, to that portion of the fan blade over which gas flows, i.e. the portion radially outside any platform.

The radius of the fan may be measured between the engine centreline and the tip of the fan blade at its leading edge. The diameter of the fan (which can generally be double the radius of the fan) may be larger than (or of the order of): 250 cm (approximately 100 inches), 260 cm (approximately 103 inches), 270 cm (approximately 105 inches), 280 cm (approximately 110 inches), 290 cm (approximately 115 inches), 300 cm (approximately 120 inches), 310 cm (approximately 123 inches), 320 cm (approximately 125 inches), 330 cm (approximately 130 inches), 340 cm (approximately 135 inches), 350 cm (approximately 139 inches), 360 cm (approximately 140 inches), 370 cm (approximately 145 inches), 380 cm (approximately 150 inches) or 390 cm (approximately 155 inches). The fan diameter may be in a closed interval delimited by two of the values in the previous sentence (i.e. the values may form upper or lower limits).

The rotational speed of the fan may vary in operation. Generally, the rotational speed is lower for fans with a larger diameter. Purely as a non-limiting example, the rotational speed of the fan under cruise conditions may be less than 2500 rpm, for example less than 2300 rpm. Purely by way of a further non-limiting example, the rotational speed of the fan under cruise conditions for an engine having a fan diameter in the range of from 250 cm to 300 cm (for example 250 cm to 280 cm) may be in the range of from 1700 rpm to 2500 rpm, for example in the range of from 1800 rpm to 2300 rpm, for example in the range of from 1900 rpm to 2100 rpm. Purely by way of a further non-limiting example, the rotational speed of the fan under cruise conditions for an engine having a fan diameter in the range of from 320 cm to 380 cm may be in the range of from 1200 rpm to 2000 rpm, for example in the range of from 1300 rpm to 1800 rpm, for example in the range of from 1400 rpm to 1600 rpm.

During the use of the gas turbine engine, the fan (with associated fan blades) rotates about a rotation axis. This rotation results in the tip of the fan blade moving with a speed Uₜᵢₚ. The work done by the fan blades on the flow results in an enthalpy rise dH of the flow. A fan tip loading may be defined as dH/Uₜᵢₚ², where dH is the enthalpy rise (for example the average 1-D enthalpy rise) across the fan and Uₜᵢₚ is the (translational) speed of the fan tip, for example at the leading edge of the tip (which can be defined as fan tip radius at the leading periphery multiplied by angular velocity). The fan tip loading under cruise conditions may be more than (or of the order of): 0.3, 0.31, 0.32, 0.33, 0.34, 0.35, 0.36, 0.37, 0.38, 0.39, or 0.4 (wherein all units in this passage are Jkg⁻¹K⁻¹/(ms⁻¹)²). The fan tip loading may be in a closed interval delimited by any two of the values in the previous sentence (that is to say the values may form upper or lower limits).

Gas turbine engines in accordance with the present disclosure may have any desired bypass ratio, wherein the bypass ratio is defined as the ratio of the mass flow rate of the flow through the bypass duct to the mass flow rate of the flow through the core under cruise conditions. In the case of some arrangements, the bypass ratio can be more than (or of the order of): 10, 10.5, 11, 11.5, 12, 12.5, 13, 13.5, 14, 14.5, 15, 15.5, 16, 16.5, or 17. The bypass ratio may be in a closed interval delimited by two of the values in the previous sentence (that is to say the values may form upper or lower limits). The bypass duct may be substantially annular. The bypass duct may be situated radially outside the core engine. The radially outer surface of the bypass duct may be defined by an engine nacelle and/or a fan casing.

The overall pressure ratio of a gas turbine engine as described and/or claimed herein may be defined as the ratio of the stagnation pressure upstream of the fan to the stagnation pressure at the exit of the highest pressure compressor (before entry into the combustor). By way of a non-limiting example, the overall pressure ratio of a gas turbine engine as described and/or claimed herein at cruising speed may be greater than (or of the order of): 35, 40, 45, 50, 55, 60, 65, 70, 75. The overall pressure ratio may be in a closed interval delimited by two of the values in the previous sentence (that is to say the values may form upper or lower limits).

The specific thrust of an engine maybe defined as the net thrust of the engine divided by the total mass flow through the engine. The specific thrust of an engine as described and/or claimed herein under cruise conditions may be less than (or of the order of): 110 Nkg⁻¹s, 105 Nkg⁻¹s, 100 Nkg⁻¹s, 95 Nkg⁻¹s, 90 Nkg⁻¹s, 85 Nkg⁻¹s or 80 Nkg⁻¹s. The specific thrust may be in a closed interval delimited by two of the values in the previous sentence (that is to say the values may form upper or lower limits). Such engines can be particularly efficient in comparison with conventional gas turbine engines.

A gas turbine engine as described and/or claimed herein may have any desired maximum thrust. Purely as a non-limiting example, a gas turbine as described and/or claimed herein may be capable of generating a maximum thrust of at least (or of the order of): 160 kN, 170 kN, 180 kN, 190 kN, 200 kN, 250 kN, 300 kN, 350 kN, 400 kN, 450 kN, 500 kN or 550 kN. The maximum thrust may be in a closed interval delimited by two of the values in the previous sentence (that is to say the values may form upper or lower limits). The thrust referred to above may be the maximum net thrust under standard atmospheric conditions at sea level plus 15° C. (ambient pressure 101.3 kPa, temperature 30° C.), with the engine static.

During use, the temperature of the flow at the entry to the high-pressure turbine can be particularly high. This temperature, which may be referred to as TET, may be measured at the exit to the combustor, for example directly upstream of the first turbine blade, which in turn may be referred to as a nozzle guide blade. At cruising speed, the TET may be at least (or of the order of): 1400 K, 1450 K, 1500 K, 1550 K, 1600 K or 1650 K. The TET at cruising speed may be in a closed interval delimited by two of the values in the previous sentence (that is to say the values may form upper or lower limits). The maximum TET during use of the engine may for example be at least (or of the order of): 1700 K, 1750 K, 1800 K, 1850 K, 1900 K, 1950 K or 2000 K. The maximum TET may be in a closed interval delimited by two of the values in the previous sentence (that is to say the values may form upper or lower limits). The maximum TET may occur, for example, under a high thrust condition, for example under a maximum take-off thrust (MTO) condition.

A fan blade and/or an aerofoil portion of a fan blade as described and/or claimed herein may be produced from any suitable material or a combination of materials. For example, at least a part of the fan blade and/or of the aerofoil may be produced at least in part from a composite, for example a metal matrix composite and/or an organic matrix composite, such as carbon fibre. By way of further example, at least a part of the fan blade and/or of the aerofoil may be produced at least in part from a metal, such as for example a titanium-based metal or an aluminium-based material (such as for example an aluminium-lithium alloy) or a steel-based material. The fan blade may comprise at least two regions produced using different materials. For example, the fan blade may have a protective leading edge, which is produced using a material that is better able to resist impact (for example from birds, ice or other material) than the rest of the blade. Such a leading edge may, for example, be produced using titanium or a titanium-based alloy. Thus, purely by way of example, the fan blade may have a carbon-fibre-based or aluminium-based body (such as an aluminium-lithium alloy) with a titanium leading periphery.

A fan as described and/or claimed herein may comprise a central portion from which the fan blades can extend, for example in a radial direction. The fan blades may be attached to the central portion in any desired manner. For example, each fan blade may comprise a fixture device which can engage with a corresponding slot in the hub (or disk). Purely as an example, such a fixture may be in the form of a dovetail that may slot into and/or be brought into engagement with a corresponding slot in the hub/disk in order to fix the fan blade to the hub/disk. By way of further example, the fan blades may be formed integrally with a central portion. Such an arrangement may be referred to as a blisk or a bling. Any suitable method may be used to produce such a blisk or such a bling. For example, at least some of the fan blades may be machined from a block and/or at least some of the fan blades may be attached to the hub/disk by welding, such as e.g. linear friction welding.

The gas turbine engines as described and/or claimed herein may or may not be provided with a variable area nozzle (VAN). Such a variable area nozzle can allow the exit cross section of the bypass duct to be varied during operation. The general principles of the present disclosure can apply to engines with or without a VAN.

The fan of a gas turbine as described and/or claimed herein may have any desired number of fan blades, for example 16, 18, 20, or 22 fan blades.

As used herein, cruise conditions may mean the cruise conditions of an aircraft to which the gas turbine engine is attached. Such cruise conditions may be conventionally defined as the conditions during the middle part of the flight, for example the conditions experienced by the aircraft and/or the engine between (in terms of time and/or distance) end of climb and start of descent.

Purely by way of an example, the forward speed under the cruise condition may be any point in the range of from Mach 0.7 to 0.9, for example 0.75 to 0.85, for example 0.76 to 0.84, for example 0.77 to 0.83, for example 0.78 to 0.82, for example 0.79 to 0.81, for example of the order of Mach 0.8, of the order of Mach 0.85 or in the range of from 0.8 to 0.85. Any arbitrary speed within these ranges can be the constant cruise condition. In the case of some aircraft, the constant cruise conditions may be outside these ranges, for example below Mach 0.7 or above Mach 0.9.

Purely by way of example, the cruise conditions may correspond to standard atmospheric conditions at an altitude that is in the range of from 10000 m to 15000 m, for example in the range of from 10000 m to 12000 m, for example in the range of from 10400 m to 11600 m (around 38000 ft), for example in the range of from 10500 m to 11500 m, for example in the range of from 10600 m to 11400 m, for example in the range of from 10700 m (around 35000 ft) to 11300 m, for example in the range of from 10800 m to 11200 m, for example in the range of from 10900 m to 11100 m, for example of the order of 11000 m. The cruise conditions may correspond to standard atmospheric conditions at any given altitude in these ranges.

Purely by way of example, the cruise conditions may correspond to the following: a forward Mach number of 0.8, a pressure of 23000 Pa and a temperature of −55° C.

As used anywhere herein, “cruising speed” or “cruise conditions” may mean the aerodynamic design point. Such an aerodynamic design point (or ADP) may correspond to the conditions (including, for example, the Mach number, ambient conditions and thrust requirement) for which the fan operation is designed. This may mean, for example, the conditions under which the fan (or gas turbine engine) has the optimum efficiency in terms of construction.

During operation, a gas turbine engine as described and/or claimed herein can operate under the cruise conditions defined elsewhere herein. Such cruise conditions may be determined by the cruise conditions (for example the conditions during the middle part of the flight) of an aircraft on which at least one (for example two or four) gas turbine engine(s) may be mounted in order to provide propulsive thrust.

It is self-evident to a person skilled in the art that a feature or parameter described in relation to one of the above aspects may be applied to any other aspect, unless these are mutually exclusive. Furthermore, any feature or any parameter described here may be applied to any aspect and/or combined with any other feature or parameter described here, unless these are mutually exclusive.

The appended figures illustrate, by way of example, possible design variants of the proposed solution.

In the figures:

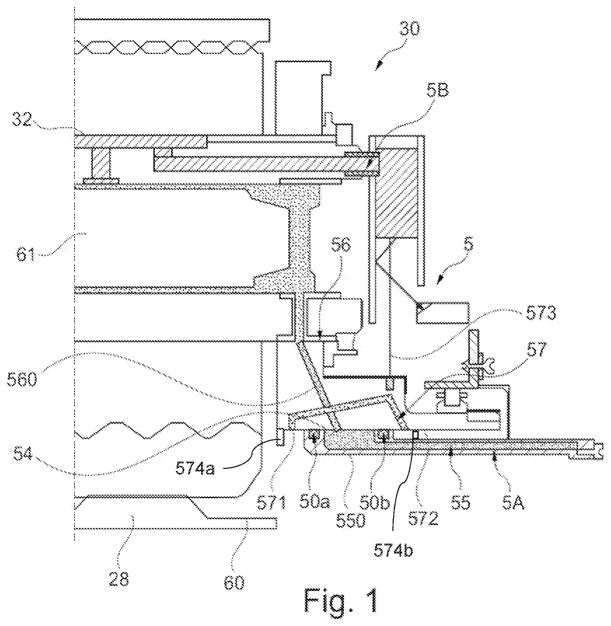

FIG. 1 shows a detail of a design variant of a proposed gear box assembly;

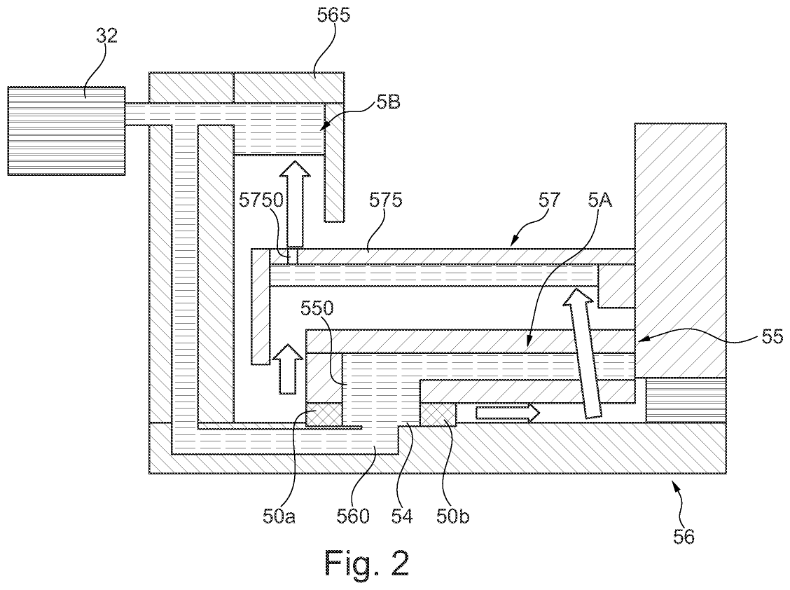

FIG. 2 schematically shows a further design variant in which a first, static part of the gear box assembly is arranged radially at the outside and a second, rotating part is arranged radially at the inside;

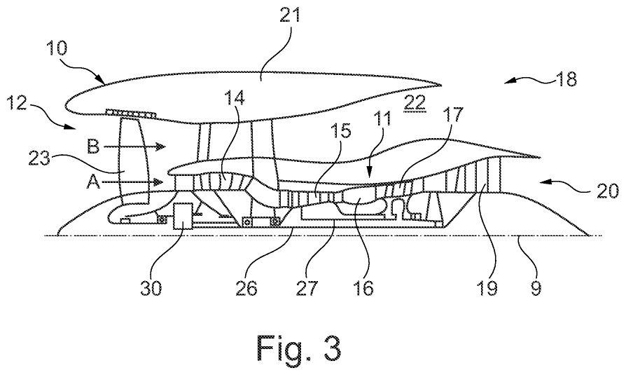

FIG. 3 shows a lateral sectional view of a gas turbine engine in which a proposed gear box assembly is used;

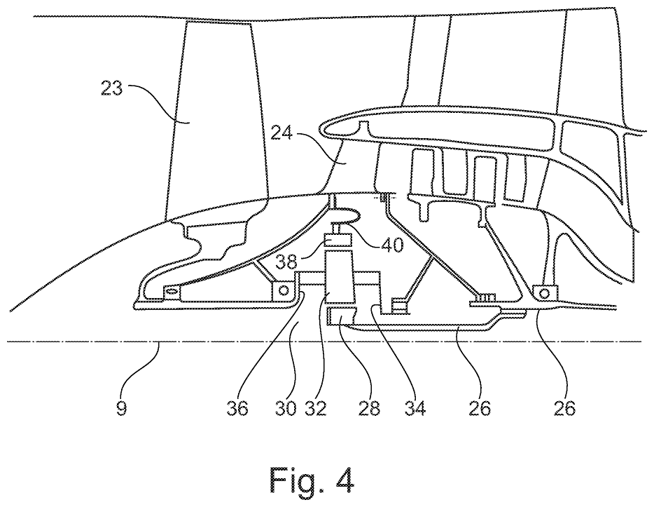

FIG. 4 shows a close-up lateral sectional view of an upstream portion of a gas turbine engine of FIG. 3;

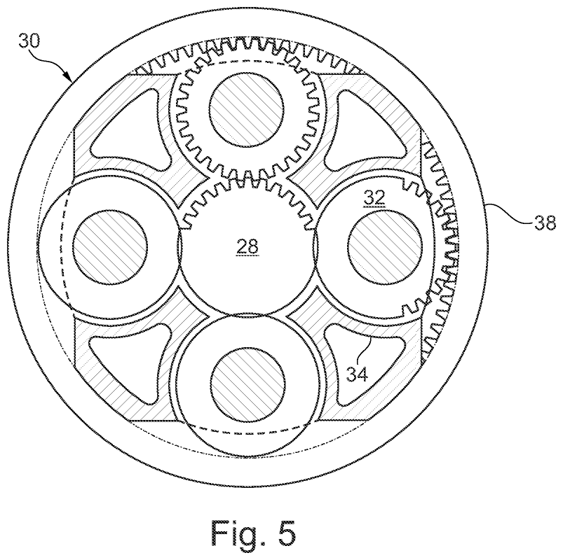

FIG. 5 shows a partially cut-away view of a gear box for a gas turbine engine of FIGS. 3 and 4.

Before design variants of a proposed gear box assembly having a conduit system 5 are described in more detail, a field of application of the proposed solution, namely a gas turbine engine 10 of an aircraft, will be described in conjunction with FIGS. 3 to 5.

FIG. 3 illustrates a gas turbine engine 10 having a main rotation axis 9. The engine 10 comprises an air intake 12 and a fan 23 that generates two air flows: a core air flow A and a bypass air flow B. The gas turbine engine 10 comprises a core 11 that receives the core air flow A. When viewed in the order corresponding to the axial direction of flow, the core engine 11 comprises a low-pressure compressor 14, a high-pressure compressor 15, a combustion device 16, a high-pressure turbine 17, a low-pressure turbine 19, and a core thrust nozzle 20. An engine nacelle 21 surrounds the gas turbine engine 10 and defines a bypass duct 22 and a bypass thrust nozzle 18. The bypass air flow B flows through the bypass duct 22. The fan 23 is attached to and driven by the low-pressure turbine 19 via a shaft 26 and an epicyclic planetary gear box 30.

During operation, the core air flow A is accelerated and compressed by the low-pressure compressor 14 and directed into the high-pressure compressor 15, where further compression takes place. The compressed air expelled from the high-pressure compressor 15 is directed into the combustion device 16, where it is mixed with fuel and the mixture is combusted. The resulting hot combustion products then propagate through the high-pressure and low-pressure turbines 17, 19 and thereby drive said turbines, before being expelled through the nozzle 20 to provide a certain thrust force. The high-pressure turbine 17 drives the high-pressure compressor 15 by way of a suitable connecting shaft 27. The fan 23 generally provides the major part of the thrust force. The epicyclic planetary gear box 30 is a reduction gear box.

An exemplary arrangement for a geared fan gas turbine engine 10 is shown in FIG. 3. The low-pressure turbine 19 (see FIG. 3) drives the shaft 26, which is coupled to a sun gear 28 of the epicyclic planetary gear box 30. Multiple planet gears 32, which are coupled to one another by a planet carrier 34, are situated radially to the outside of the sun gear 28 and mesh therewith. The planet carrier 34 guides the planet gears 32 in such a way that they circulate synchronously around the sun gear 28, whilst enabling each planet gear 32 to rotate about its own axis. The planet carrier 34 is coupled via linkages 36 to the fan 23 in order to drive its rotation about the engine axis 9. An external gear or ring gear 38 that is coupled via linkages 40 to a stationary support structure 24 is situated radially to the outside of the planet gears 32 and meshes therewith.

It should be noted that the expressions “low-pressure turbine” and “low-pressure compressor”, as used herein, can be taken to mean the lowest-pressure turbine stage and lowest-pressure compressor stage (i.e. not including the fan 23), respectively, and/or the turbine and compressor stages that are connected together by the connecting shaft 26 with the lowest rotational speed in the engine (i.e. not including the gear box output shaft that drives the fan 23). In some documents, the “low-pressure turbine” and the “low-pressure compressor” referred to herein may alternatively be known as the “intermediate-pressure turbine” and “intermediate-pressure compressor”. Where such alternative nomenclature is used, the fan 23 may be referred to as a first, or lowest-pressure, compression stage.

The epicyclic planetary gear box 30 is shown in greater detail by way of example in FIG. 5. The sun gear 28, planet gears 32 and ring gear 38 in each case comprise teeth on their periphery to allow meshing with the other toothed gears. However, for clarity, only exemplary portions of the teeth are illustrated in FIG. 5. Although four planet gears 32 are illustrated, it will be apparent to a person skilled in the art that more or fewer planet gears 32 may be provided within the scope of protection of the claimed invention. Practical applications of an epicyclic planetary gear box 30 generally comprise at least three planet gears 32.

The epicyclic planetary gear box 30 illustrated by way of example in FIGS. 4 and 5 is a planetary gear box in which the planet carrier 34 is coupled to an output shaft via linkages 36, with the ring gear 38 being fixed. However, any other suitable type of planetary gear box 30 may be used. As a further example, the planetary gear box 30 may be a star arrangement, in which the planet carrier 34 is held fixed, with the ring gear (or external gear) 38 being allowed to rotate. In such an arrangement, the fan 23 is driven by the ring gear 38. As a further alternative example, the gear box 30 may be a differential gear box in which both the ring gear 38 and the planet carrier 34 are allowed to rotate.

It is self-evident that the arrangement shown in FIGS. 4 and 5 is merely an example, and various alternatives fall within the scope of protection of the present disclosure. Purely by way of example, any suitable arrangement can be used for positioning the gear box 30 in the engine 10 and/or for connecting the gear box 30 to the engine 10. Byway of a further example, the connections (such as the linkages 36, 40 in the example of FIG. 4) between the gear box 30 and other parts of the engine 10 (such as the input shaft 26, the output shaft and the fixed structure 24) may have a certain degree of stiffness or flexibility. As a further example, any suitable arrangement of the bearings between rotating and stationary parts of the engine 10 (for example between the input and output shafts of the gear box and the fixed structures, such as the gear casing) may be used, and the disclosure is not limited to the exemplary arrangement of FIG. 4. For example, where the gear box 30 has a star arrangement (described above), a person skilled in the art would readily understand that the arrangement of output and support linkages and bearing positions would usually be different from that shown byway of example in FIG. 4.

Accordingly, the present disclosure extends to a gas turbine engine having any arrangement of gear box types (for example star-shaped or epicyclic-planetary), support structures, input and output shaft arrangement, and bearing positions.

Optionally, the gear box may drive additional and/or alternative components (for example the intermediate-pressure compressor and/or a booster compressor).

Other gas turbine engines in which the present disclosure can be used may have alternative configurations. For example, such engines may have an alternative number of compressors and/or turbines and/or an alternative number of connecting shafts. As a further example, the gas turbine engine shown in FIG. 3 has a split flow nozzle 20, 22, meaning that the flow through the bypass duct 22 has its own nozzle, which is separate from and radially outside the engine core nozzle 20. However, this is not restrictive, and any aspect of the present disclosure can also apply to engines in which the flow through the bypass duct 22 and the flow through the core 11 are mixed or combined before (or upstream of) a single nozzle, which may be referred to as a mixed flow nozzle. One or both nozzles (whether mixed or split flow) can have a fixed or variable region. Although the example described relates to a turbofan engine, the disclosure may be applied for example to any type of gas turbine engine, for example an open-rotor engine (in which the fan stage is not surrounded by an engine nacelle) or a turboprop engine. In some arrangements, the gas turbine engine 10 potentially does not comprise a gear box 30.

The geometry of the gas turbine engine 10, and components thereof, is/are defined by a conventional axis system, which comprises an axial direction (which is aligned with the rotation axis 9), a radial direction (in the direction from bottom to top in FIG. 3), and a circumferential direction (perpendicular to the view in FIG. 3). The axial, radial and circumferential directions are mutually perpendicular.

For lubrication and/or heat dissipation, provision may be made for a friction-releasing and/or cooling fluid, for example oil, to be conveyed to various points of the planetary gear box 30. For example, specifically with regard to the high rotational speeds of rotating (gear box) elements of the planetary gear box 30, provision may be made for oil to be supplied to bearings for these rotating elements and/or to toothed gear pairings at this planetary gear box 30. This relates for example to a plain bearing arrangement for a planet gear 32 on the planet carrier 34. Here, in order to provide the greatest possible degree of fail safety, a conduit system 5 is provided for conveying oil to a corresponding plain bearing, which conduit system comprises two supply lines 5A and 5B, via which oil can be conducted in redundant fashion to the respective planet gear 32. A supply line 5A, 5B may then for example also be coupled to a respectively dedicated oil pump.

In the present case, the planet gear 32 rotates in each case about a journal 61 of the planetary gear box 30. This journal 61 is likewise illustrated as a detail in FIG. 1 together with a sun gear 28 of the planetary gear box 30. The sun gear 28 of the planetary gear box 30 can be driven via a drive shaft 60. In relation to a rotation axis of the sun gear 28 or of the drive shaft 60, the conduit system with the first supply line 5A is situated radially further to the outside, in order to convey oil under pressure through channels of the conduit system 5 from the region of the casing of the gas turbine engine 10 in the direction of the planetary gear box 30 (from the right in FIG. 1).

During the conveyance of oil to the planet carrier 32, there is however then the fundamental difficulty that the oil must be conveyed from a first, static part 55 in the gas turbine engine 10 to a second, rotating part 56, which is connected to the planet carrier 32. For this purpose, in the design variant illustrated in FIG. 1, a first, static duct portion 550 of the first, static part 55 and a second, rotating duct portion 560 of the rotating part 56 are connected to one another via a transition region 54 such that oil can flow from the static duct portion 550 of the rotating part 55 into the rotating duct portion 560 of the rotating part 561 in order to convey oil via the first supply line 5A to the plain bearing of the planet carrier 32. One or more outflow openings of the first duct portion 550 into the transition region 54 are thus in this case situated opposite one or more inflow openings of the second duct portion 560 at the transition region 54, such that oil can flow across the transition region 54 from the first duct portion 550 into the second duct portion 560.

In order to be able to convey oil via the first supply line 5A in the direction of the planet carrier 32, a seal is provided between the static part 55 and the rotating part 56 at the transition region 54. The transition region 54 is thus sealed off with respect to the second rotating part 56, wherein, for this purpose, seals 50a and 50b, in this case each in the form of circumferentially encircling sealing rings (for example in the form of rectangular-section sealing rings) are provided to both sides of the transition region 54 in an axial direction. The seals 50a and 50b are arranged in associated groove devices of the static part 55. A groove device is in this case formed, so as to be substantially U-shaped in cross section, in the static part 55, wherein the respective seal 50a, 50b does not completely fill its groove device. During the operation of the gas turbine engine 10 and thus during the operation of the planetary gear box 30, it is thus in particular not possible to entirely rule out a situation in which an at least slight leakage flow passes across the respective seal 50a or 50b. Here, a corresponding leakage flow reduces the oil quantity that is available for the first supply line 5A.

As part of the illustrated design variant of the proposed solution, provision is now made for the conduit system 5 to be equipped with a leakage recovery facility 57, by means of which in each case at least a proportion of a leakage flow of oil which originates from the first duct portion 550 and which flows across one of the seals 50a and 50b is conducted to the second supply line 5B. Oil which escapes from the transition region 54 and which is attributable to a leak in the region of one of the seals 50a, 50b is in this case consequently utilized for the second supply line 5B that is provided for the redundant lubrication of the bearing arrangement of a planet gear 34.

For this purpose, the leakage recovery facility 57 has two feed openings 571 and 572 in the second, rotating part 56. Each feed opening 571, 572, which may then for example also be of circumferentially encircling form on a radially inner side of the second, rotating part 56, is assigned to one of the seals 50a, 50b. Thus, in relation to a possible leakage flow across a first seal 50a, a first feed opening 571 is situated downstream of, and thus so as to be spaced apart in a first axial direction along the rotation axis of the second, rotating part 56 from, the first seal 50a (and thus to the left of the first seal 50a in the cross-sectional view of FIG. 1). In turn, in relation to a possible leakage flow across said second seal 50b, the other, second feed opening 572 is situated downstream of, and so as to be spaced apart axially in an opposite axial direction from, the second seal 50b (and thus to the right of the second seal 50b in the cross-sectional view of FIG. 1). The transition region 54, with the seals 50a and 50b that border it axially, is thus consequently situated between the two feed openings 571 and 572. In the event of any leak in the region of the seals 50a, 50b, it is thus possible for oil that originates from a leak to be conveyed, under the action of the centrifugal force that arises during the operation of the planetary gear box 30, via a respective feed opening 571 or 572 into a connecting conduit 573 that opens into the second supply line 5b. Here, the feed openings 571 and 572 are each part of at least partially radially extending conduit portions within the second, rotating part 56, which each open into the connecting conduit 573.

In the design variant illustrated, downstream of at least one or else of both feed openings 571, 572, there is provided in each case one radially projecting catch plate 574a or 574b of the leakage recovery facility 57. The respective, annularly encircling catch plate 574a, 574b projects in each case radially inwards on the second, rotating part 56 and thus delimits a space that is available in an axial direction for a respective leakage flow that occurs across a respective seal 50a or 50b. One or more catch plates 574a, 574b may be advantageous in particular with regard to relatively high outflow speeds of a leakage flow.

FIG. 2 schematically illustrates a further design variant of the proposed solution. Here, by contrast to the design variant of FIG. 1, the second, rotating part 56 is arranged radially at the inside. The first, static part 55 is thus situated radially at the outside.

Analogously to the design variant of FIG. 1, a leakage recovery facility 57 is also provided here in order to conduct at least a proportion of a leakage flow of fluid, which originates from the duct portion 550 and which flows across one of the seals 50a, 50b, to the second supply line 5B of the second, rotating part 56. Owing to the “reversed” arrangement of the static and rotating parts 55, 56 in relation to the design variant of FIG. 1, the leakage recovery facility 57 additionally comprises a static (first) catch pan 575. Oil that has escaped from the transfer region 54 as leakage across the seals 50a, 50b is collected at this catch pan 575, which is situated radially further to the outside than the first, static part 55.

Oil can be conducted radially further outwards from the first, static catch pan 575 via one or more connecting openings 5750 at the static catch pan 575. In the present case, oil originating from a leak is conducted in this way to a second (rotating) catch or collecting pan 565 on the second, rotating part 56. Oil is fed from this second catch or collecting pan 565 to the second supply line 5B.

In the illustrated design variant of a proposed gear box assembly corresponding to FIG. 1 or 2, oil that is attributable to a leak in the first supply line 5A in the transition region 54 thus passes in each case at least partially or entirely into the second supply line 5B, which is likewise provided for lubrication of the bearing arrangement of the planet gears 34. In this way, a gear box assembly with the planetary gear box 30 and the conduit system 5 can be made more lightweight, because, during operation, any leakage in the transition region 54 of the first supply line 5A does not inevitably lead to a significant loss of oil in the system as a whole, and therefore a quantity of oil that must be provided in the conduit system 5 is lower. Furthermore, a certain leakage in the region of the seals 50a, 50b can be more easily tolerated with regard to improved wear characteristics of the seals 50a, 50b. This in turn improves the robustness of the planetary gear box 30 with respect to any wear-induced damage to the seals 50a, 50b.

It is self-evident that the invention is not limited to the embodiments described above, and various modifications and improvements can be made without departing from the concepts described herein. Any of the features may be used separately or in combination with any other features, unless they are mutually exclusive, and the disclosure extends to and includes all combinations and subcombinations of one or more features that are described herein.

### LIST OF REFERENCE DESIGNATIONS

9 Main rotation axis
10 Gas turbine engine
11 Core engine
12 Air inlet
14 Low-pressure compressor
15 High-pressure compressor
16 Combustion device
17 High-pressure turbine
18 Bypass thrust nozzle
19 Low-pressure turbine
20 Core thrust nozzle
21 Engine nacelle
22 Bypass duct
23 Fan
24 Stationary support structure
26 Shaft
27 Connecting shaft
28 Sun gear
30 (Planetary) gear box
32 Planet gears
34 Planet carrier
36 Linkage
38 Ring gear
40 Linkage
5 Conduit system
5A, 5B First/second supply line
50a, 50b Seal
54 Transition region
55 Static part
550 Static duct portion
56 Rotating part
560 Rotating duct portion
565 Catch/collecting pan
57 Leakage recovery facility
571, 572 Feed opening
573 Connecting conduit
574a/b Catch plate
575 Catch pan
5750 Connecting opening
60 Drive shaft
61 Journal for planet gear
A Core air flow
B Bypass air flow

1. A gear box assembly for an engine, having
a gear box for transmitting a torque,
at least one first, static part,
at least one second, rotating part, which is mounted so as to be rotatable relative to the first, static part and on which at least one element of the gear box is provided, and
a conduit system for conveying a fluid to elements of the gear box,
wherein the conduit system has at least one first supply line and one second supply line for supplying fluid to at least one element of the gear box, and
wherein the first supply line has a first duct portion in the first, static part and a second duct portion in the second, rotating part, and the second duct portion is connected to the first duct portion via a transition region that is sealed off with respect to the second, rotating part by means of at least one seal,
wherein
a leakage recovery facility is provided, by means of which at least a proportion of a leakage flow of fluid which originates from the first duct portion and which flows across the at least one seal can be conducted to the second supply line.

2. The gear box assembly according to claim 1, wherein the leakage recovery facility comprises a feed opening which is situated, in relation to the leakage flow, downstream of the at least one seal in the second, rotating part and via which inflowing fluid can be conducted to a connecting conduit that is connected to the second supply line.

3. The gear box assembly according to claim 2, wherein the leakage recovery facility is configured to, during the operation of the gear box, convey fluid of the leakage flow through the feed opening in the direction of the connecting conduit under the action of a centrifugal force.

4. The gear box assembly according to claim 2, wherein the leakage recovery facility comprises, downstream of the feed opening, at least one catch plate that projects radially in relation to a rotation axis of the second, rotating part.

5. The gear box assembly according to claim 1, wherein the conduit system has at least two seals which are spaced apart from one another axially in relation to a rotation axis of the second, rotating part, and, by means of the leakage recovery facility, both at least a proportion of a leakage flow of fluid which originates from the first duct portion and which flows across a first seal and at least a proportion of a leakage flow of fluid which originates from the first duct portion and which flows across an axially spaced-apart second seal can be conducted to the second supply line.

6. The gear box assembly according to claim 2, wherein the leakage recovery facility comprises at least two feed openings in the second, rotating part, via each of which inflowing fluid can be conducted to a connecting conduit connected to the second supply line and between which, in an axial direction in relation to a rotation axis of the second, rotating part, the first and second seals are provided.

7. The gear box assembly according to claim 6, wherein the leakage recovery facility comprises at least two catch plates which each project radially and which are assigned to a respective feed opening.

8. The gear box assembly according to claim 1, wherein the leakage recovery facility comprises, on the first, static part, at least one catch pan for fluid from a leakage flow.

9. The gear box assembly according to claim 1, wherein the first and second supply lines are provided for the redundant supply of fluid to at least one element of the gear box.

10. The gear box assembly according to claim 1, wherein the first and/or second supply line are/is provided for conveying the fluid to at least one bearing, which is to be lubricated with the fluid, of the gear box.

11. The gear box assembly according to claim 1, wherein the gear box is configured as a planetary gear box.

12. The gear box assembly according to claim 11, wherein the conduit system is part of an oil supply for a planet carrier of the planetary gear box.

13. The gear box assembly according to claim 12, wherein the conduit system is provided for lubricating a bearing arrangement by means of which a planet gear of the planetary gear box is mounted rotatably on the planet carrier.

14. The gear box assembly according to claim 11, wherein the first and second duct portions are arranged radially offset with respect to one another in relation to a rotation axis of the gear box.

15. An engine having a gear box assembly according to claim 1.

16. The engine according to claim 15, which at least comprises:
a core engine that comprises a turbine, a compressor, and a core shaft connecting the turbine to the compressor, and
a fan that is positioned upstream of the core engine, wherein the fan comprises a plurality of fan blades,
wherein the gear box of the gear box assembly can be driven by the core shaft, and the fan can be driven at a lower rotational speed than the core shaft by means of the gear box.
